(19) United States
(12) Patent Application Publication
(10) Pub. No.: US 2025/0184926 A1
(43) Pub. Date: Jun. 5, 2025

(54) METHODS AND APPARATUS FOR ENHANCED WIRELESS NETWORK ACCESS

(71) Applicant: HUAWEI TECHNOLOGIES CO., LTD., Shenzhen (CN)

(72) Inventors: Alireza Bayesteh, Kanata (CA); Aman Jassal, Kanata (CA); Amine Maaref, Ottawa (CA)

(21) Appl. No.: 19/047,854

(22) Filed: Feb. 7, 2025

Related U.S. Application Data
(63) Continuation of application No. PCT/CN2022/111103, filed on Aug. 9, 2022.

(51) Int. Cl. H04W 56/00; H04W 64/00

(52) U.S. Cl. CPC H04W 56/00; H04W 64/00

(57) ABSTRACT

Aspects of the present disclosure provide an enhanced procedure for wireless network access and, in particular examples, a location-aware access procedure in which the location of an apparatus is used to streamline the access procedure for enabling the apparatus to access the network. The location of the apparatus may be used to inform transmission of a synchronization message to the apparatus. The apparatus may transmit a request to access a network based on its location relative to another apparatus in the network. Using the location of the apparatus can reduce network overhead and latency, whilst saving power at the apparatus.

### CROSS-REFERENCE TO RELATED APPLICATION

This application is a continuation of Patent Cooperation Treaty Application Serial No. PCT/CN2022/111103, entitled “Methods and Apparatus for Enhanced Wireless Network Access” filed on Aug. 9, 2022, the content of which is incorporated herein by reference in its entirety.

### TECHNICAL FIELD

The present application relates to communication networks and, in particular, to methods and apparatus relating to connecting an apparatus to a communication network.

### BACKGROUND

In the context of wireless communication networks, access procedures may be implemented to provide electronic devices with access to network information, such as configuration information. As well as enabling electronic devices to access a network (e.g., allowing devices to go from an unconnected to a connected state), access procedures may also be used to connect idle or sleeping electronic devices to the network.

An access procedure, which may be referred to as an initial access (IA) procedure, may begin with a transmit and receive point (TRP) periodically transmitting a synchronization signal block (SSB). The SSB comprises a primary synchronization signal (PSS), a synchronization signal (SSS) and a physical broadcast channel (PBCH). In order for electronic devices within the coverage area of the TRP to receive the SSB, the TRP performs an exhaustive beam sweeping routine, in which the SSB is transmitted over a large number of beams in order to cover as much of the coverage area of the TRP as possible. Electronic devices seeking to connect to the network perform an exhaustive search regime in order to detect the broadcast SSBs. This exhaustive beam sweeping and searching mechanism for detecting and receiving SSBs may not be cost-efficient, as it can incur considerable network overhead, power consumption, and latency.

As communication networks are increasingly being designed for higher carrier frequencies (e.g., millimeter-wave), beam sweeping is expected to become more cumbersome since beam width typically decreases with increasing carrier frequency. In order to cover the same region, conventional beam sweeping and searching techniques will require more beams from both TRPs and electronic devices.

At the same, it is desirable to minimize power consumption at the electronic device. One way of achieving this is to allow electronic devices to spend more time in an idle state (e.g., sleeping) and less time in a connected state. However, each time an electronic device seeks to access the network from an idle state may necessitate performing an access procedure, such as the access procedure described above, which may incur further power consumption, network overhead and delay in accessing the network.

### SUMMARY

One of the challenges of existing access procedures for wireless communications network is that the network may not be aware of which electronic devices seek to access the network, nor where such devices may be found. Similarly, an electronic device seeking to access a network may only become aware of a nearby TRP responsive to receiving an SSB from the TRP. As a result, existing access procedures require extensive beam sweeping which can incur considerable network overhead, power consumption, and latency.

Aspects of the present disclosure provide an enhanced procedure for wireless network access and, in particular examples, a location-aware access procedure in which the location of an apparatus is used to streamline the access procedure for enabling the apparatus to access the network. The location of the apparatus may, for example, be used to inform transmission of a synchronization message to the apparatus. In another example, the apparatus may transmit a request to access a network based on its location relative to another apparatus in the network. Using the location of the apparatus to inform the access procedure enables reducing or removing the need to perform beam sweeping as part of the access procedure, which reduces network overhead and latency. This also reduces or removes the need for such an exhaustive search procedure at the apparatus, which reduces power consumption at the apparatus.

In one aspect, a method performed by a network device in a communications network is provided. The method comprises receiving a request to connect a first apparatus to the communications network, obtaining location information indicating a location of the first apparatus, and initiating transmission of a synchronization message to the first apparatus based on the location information.

In an example, obtaining the location information may comprise receiving the location information from a second apparatus in the communications network.

In an example, receiving the location information from the second apparatus may comprise receiving the location information from a sensing apparatus.

In an example, receiving the location from the sensing apparatus may comprise receiving the location information from a non-terrestrial network device or a terminal device.

The method may further comprise instructing the second apparatus to monitor the location of the apparatus. Instructing the second apparatus to monitor the location of the first apparatus may be performed responsive to determining that the first apparatus is in an idle state.

In an example, the request to connect the first apparatus to the communications network may be received from the second apparatus. The request to connect the first apparatus to the communications network may be received over a Physical Uplink Shared Channel or a Physical Uplink Control Channel.

In an example, initiating transmission of the synchronization message to the first apparatus may comprise instructing the second apparatus to transmit the synchronization message to the first apparatus.

In an example, obtaining the location information may comprise receiving the location information from the first apparatus. The request to connect the first apparatus to the communications network may be received from the first apparatus.

In an example, initiating transmission of a synchronization message to the first apparatus based on the location information may comprise initiating transmission of the synchronization message to the first apparatus using one or more beams, in which the one or more beams are determined based on the location information. The one or more beams may comprise a subset selected from a plurality of beams based on the location information.

The synchronization message may comprise at least one of a primary synchronization signal and a secondary synchronization signal.

The synchronization message may comprise a master information block. The synchronization message may comprise a synchronization signal block.

A network device configured to perform any one of the aforementioned methods is also provided. In yet another aspect, a memory is provided. The memory contains instructions which, when executed by a processor, cause the processor to perform any one of the methods described above.

In another aspect, a method performed by a first apparatus is provided. The method comprises determining a first location of the first apparatus, obtaining a second location of a second apparatus in a communications network, and based on the first location and the second location, transmitting a request, to the second apparatus, to access the communications network.

The method may further comprise transmitting an indication of the first location to the second apparatus.

In an example, the request may be transmitted with a timing advance determined based on the first location and the second location.

In an example, obtaining the second location of the second apparatus may comprise determining the second location of the second apparatus based on the first location and a map of the communications network.

In an example, determining the first location of the first apparatus may comprise storing an initial location of the first apparatus in response to transitioning to an idle state, obtaining movement information using one or more sensors in the first apparatus, and determining the first location of the first apparatus based on the initial location and the movement information.

In an example, determining the first location of the first apparatus may comprise transmitting a sensing signal, receiving a reflection of the sensing signal, wherein the reflection comprises an indicator of a tag, and determining the first location of the first apparatus based on the indicator of the tag.

The method may further comprise detecting a synchronization message transmitted by the second apparatus.

The method may further comprise detecting a synchronization message transmitted by a network device in the wireless communication network.

A first apparatus configured to perform any one of the aforementioned methods is also provided. In yet another aspect, a memory is provided. The memory contains instructions which, when executed by a processor, cause the processor to perform any one of the methods described above.

In an aspect, a method performed by a first apparatus in a communications network is provided. The method comprises obtaining a first indication of a request, by a second apparatus, to access the communications network, and sending, to a network device in the communications network, a second indication of the request, by the second apparatus, to access the communications network.

The method may further comprise sending a signal towards the second apparatus, and receiving a reflection of the transmission from the second apparatus, in which the reflection comprises the first indication of the request.

In an example, obtaining the first indication of the request, by the second apparatus, to access the communications network may comprise receiving the request from the second apparatus.

The method may further comprise obtaining a location of the second apparatus and transmitting the location of the second apparatus to the network device. Obtaining the location of the second apparatus may comprise receiving location information from the second apparatus, or performing sensing to determine the location of the second apparatus.

The method may further comprise receiving an instruction from the network device, and transmitting a synchronization message to the second apparatus. The synchronization message may be transmitted using one or more beams determined based on the location of the second apparatus. The one or more beams may comprise a subset selected from a plurality of beams based on the location of the second apparatus.

A first apparatus configured to perform any one of the aforementioned methods is also provided. In yet another aspect, a memory is provided. The memory contains instructions which, when executed by a processor, cause the processor to perform any one of the methods described above.

In an aspect, a method performed by a network device in a communications network is provided. The method comprises obtaining a location of a first apparatus, and based on the location of the first apparatus, sending an instruction, to a second apparatus in the communications network, to transmit a synchronization message to the first apparatus.

A network device configured to perform the aforementioned method is also provided. In yet another aspect, a memory is provided. The memory contains instructions which, when executed by a processor, cause the processor to perform the method described above.

In another aspect, a method performed by a first apparatus in a communications network is provided. The method comprises receiving, from a network device in the communications network, an instruction to transmit a synchronization message to a second apparatus, and transmitting the synchronization message to the second apparatus based on the location of the first apparatus.

A first apparatus configured to perform the aforementioned method is also provided. In yet another aspect, a memory is provided. The memory contains instructions which, when executed by a processor, cause the processor to perform the method described above.

In one aspect, a network device for a communications network is provided. The network device comprises a memory storing instructions and a processor. The processor is caused, by executing the instructions, to receive a request to connect a first apparatus to the communications network, obtain location information indicating a location of the first apparatus, and initiate transmission of a synchronization message to the first apparatus based on the location information.

In a further aspect, the processor may be further caused, by executing the instructions, to obtain the location information by receiving the location information from a second apparatus in the communications network.

In a further aspect, the processor may be further caused, by executing the instructions, to receive the location information from the second apparatus by receiving the location information from a sensing apparatus.

In a further aspect, the processor may be further caused, by executing the instructions, to receive the location from the sensing apparatus by receiving the location information from a non-terrestrial network device or a terminal device.

In a further aspect, the processor may be further caused, by executing the instructions, to instruct the second apparatus to monitor the location of the apparatus. The processor may be further caused, by executing the instructions to instruct the second apparatus to monitor the location of the first apparatus responsive to determining that the first apparatus is in an idle state.

In a further aspect, the processor may be further caused, by executing the instructions, to receive the request to connect the first apparatus to the communications network from the second apparatus. The processor may be further caused, by executing the instructions to receive the request to connect the first apparatus to the communications network over a Physical Uplink Shared Channel or a Physical Uplink Control Channel.

In a further aspect, the processor may be further caused, by executing the instructions, to initiate transmission of the synchronization message to the first apparatus by instructing the second apparatus to transmit the synchronization message to the first apparatus.

In a further aspect, the processor may be further caused, by executing the instructions, to obtain the location information by receiving the location information from the first apparatus. The processor may be further caused, by executing the instructions, to receive the request to connect the first apparatus to the communications network from the first apparatus.

In a further aspect, the processor may be further caused, by executing the instructions, to initiate transmission of a synchronization message to the first apparatus based on the location information by initiating transmission of the synchronization message to the first apparatus using one or more beams, in which the one or more beams are determined based on the location information. The one or more beams may comprise a subset selected from a plurality of beams based on the location information.

The synchronization message may comprise at least one of a primary synchronization signal and a secondary synchronization signal.

The synchronization message may comprise a master information block. The synchronization message may comprise a synchronization signal block.

In another aspect, a first apparatus is provided. The first apparatus comprises a memory storing instructions and a processor. The processor is caused, by executing the instructions, to determine a first location of the first apparatus, obtain a second location of a second apparatus in a communications network, and based on the first location and the second location, transmit a request, to the second apparatus, to access the communications network.

In a further aspect, the processor may be further caused, by executing the instructions, to transmit an indication of the first location to the second apparatus.

In a further aspect, the processor may be further caused, by executing the instructions, to transmit the request with a timing advance determined based on the first location and the second location.

In a further aspect, the processor may be further caused, by executing the instructions, to determine the second location of the second apparatus by determining the second location of the second apparatus based on the first location and a map of the communications network.

In a further aspect, the processor may be further caused, by executing the instructions, to determine the first location of the first apparatus by storing an initial location of the first apparatus in response to transitioning to an idle state, obtaining movement information using one or more sensors in the first apparatus, and determining the first location of the first apparatus based on the initial location and the movement information.

In a further aspect, the processor may be further caused, by executing the instructions, to determine the first location of the first apparatus by transmitting a sensing signal, receiving a reflection of the sensing signal, in which the reflection comprises an indicator of a tag, and determining the first location of the first apparatus based on the indicator of the tag.

In a further aspect, the processor may be further caused, by executing the instructions, to detect a synchronization message transmitted by the second apparatus.

In a further aspect, the processor may be further caused, by executing the instructions, to detect a synchronization message transmitted by a network device in the wireless communication network.

In an aspect, a first apparatus for a communications network is provided. The first apparatus comprises a memory storing instructions and a processor. The processor is caused, by executing the instructions, to obtain a first indication of a request, by a second apparatus, to access the communications network, and send, to a network device in the communications network, a second indication of the request, by the second apparatus, to access the communications network.

In a further aspect, the processor may be further caused, by executing the instructions, to send a signal towards the second apparatus, and receive a reflection of the transmission from the second apparatus, in which the reflection comprises the first indication of the request.

In a further aspect, the processor may be further caused, by executing the instructions, to obtain the first indication of the request, by the second apparatus, to access the communications network by receiving the request from the second apparatus.

In a further aspect, the processor may be further caused, by executing the instructions, to obtain a location of the second apparatus and transmit the location of the second apparatus to the network device. The processor may be further caused, by executing the instructions, to obtain the location of the second apparatus by receiving location information from the second apparatus or performing sensing to determine the location of the second apparatus.

In a further aspect, the processor may be further caused, by executing the instructions, to receive an instruction from the network device, and transmit a synchronization message to the second apparatus. The processor may be caused, by executing the instructions, to transmit the synchronization message using one or more beams determined based on the location of the second apparatus. The one or more beams may comprise a subset selected from a plurality of beams based on the location of the second apparatus.

In an aspect, a network device for a communications network is provided. The network device comprises a memory storing instructions and processor. The processor is caused, by execution of the instructions, to obtain a location of a first apparatus, and based on the location of the first apparatus, send an instruction, to a second apparatus in the communications network, to transmit a synchronization message to the first apparatus.

In another aspect, a first apparatus for a communications network is provided. The first apparatus comprises a memory storing instructions and processor. The processor is caused, by execution of the instructions, to receive, from a network device in the communications network, an instruction to transmit a synchronization message to a second apparatus, and transmit the synchronization message to the second apparatus based on the location of the first apparatus.

In another aspect, a system is provided. The system comprises a first apparatus at a first location. The first apparatus is configured to transmit a request to access a communication network. The system further comprises a network device of the communication network. The network device is configured to transmit a synchronization message instruction responsive to the request. The system further comprises a second apparatus in communication with both the first apparatus and the network device. The second apparatus is configured to receive the instruction and transmit, to the first apparatus, a synchronization message based on the first location of the first apparatus.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a communication system in which embodiments of the disclosure may occur;

FIG. 2 is another schematic diagram of a communication system in which embodiments of the disclosure may occur;

FIG. 3 is a block diagram illustrating units or modules in a device in which embodiments of the disclosure may occur;

FIG. 4 is a block diagram illustrating units or modules in a device in which embodiments of the disclosure may occur;

FIGS. 5 and 6 show diagrams of signaling according to embodiments of the disclosure; and

FIGS. 7-11 show flowcharts of methods according to embodiments of the disclosure.

### DETAILED DESCRIPTION

The operation of the current example embodiments and the structure thereof are discussed in detail below. It should be appreciated, however, that the present disclosure provides many applicable inventive concepts that can be embodied in any of a wide variety of specific contexts. The specific embodiments discussed are merely illustrative of specific structures of the disclosure and ways to operate the disclosure, and do not limit the scope of the present disclosure.

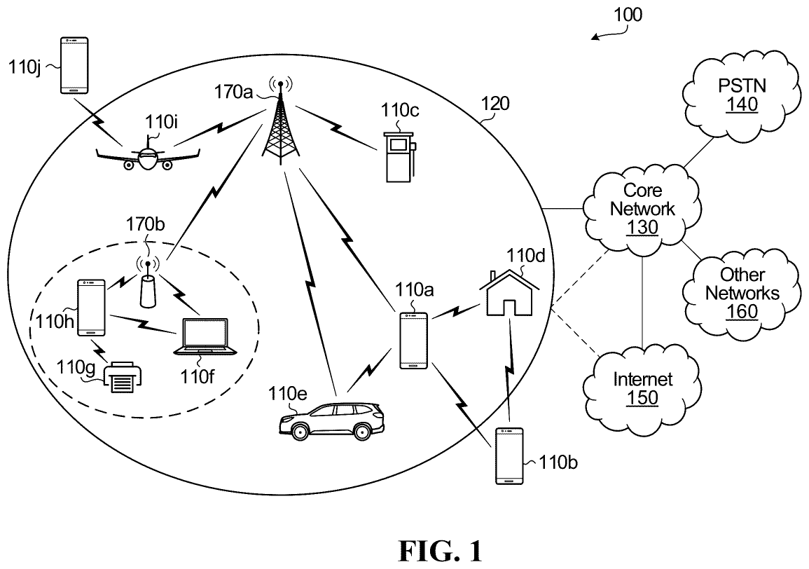

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electronic device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

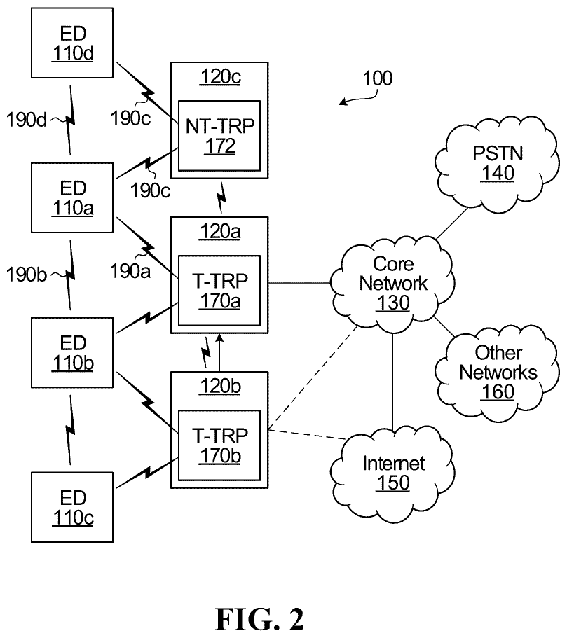

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), discrete Fourier transform OFDMA (DFT-OFDMA) or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

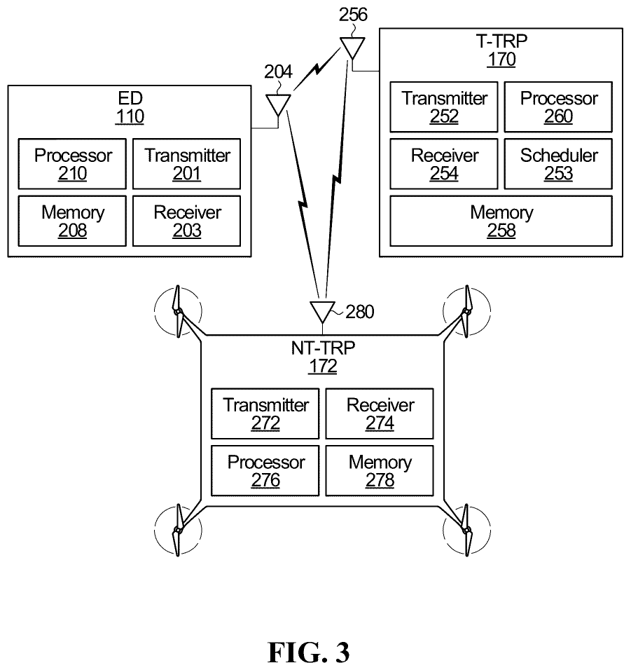

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), MR (Mixed reality), Metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearables devices such as watches, head mounted equipment, glasses, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a CPU, a GPU, or an ASIC.

Although the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a CPU, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

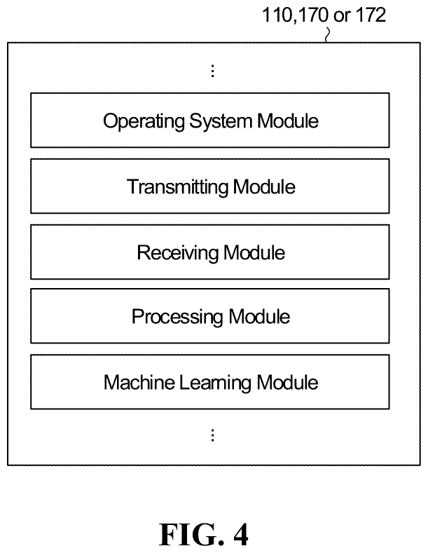

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a CPU, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

### Network Access

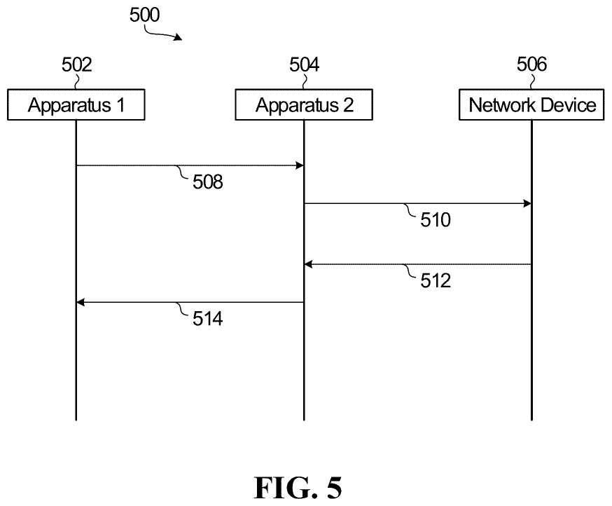

FIG. 5 shows a diagram of signaling 500 between a first apparatus 502, a second apparatus 504 and a network device 506 according to embodiments of the disclosure.

The signaling 500 may form part of an access procedure for connecting the first apparatus 502 to a communications network via the network device 506. As such, the first apparatus 502 may initially not be connected to the communications network. Thus, for example, the first apparatus 502 may have been previously connected to the communications network and since disconnected. The first apparatus may be in an idle or low power (e.g., sleeping) state, such as, for example, a Radio Resource Control (RRC) IDLE state. In another example, the first apparatus 502 may have never been connected to the communications network and may be seeking access for the first time.

The first apparatus 502 may be any suitable apparatus that can connect to the communications network. In particular examples, the first apparatus 502 may be an electronic device such as, for example, any of the electronic devices 110a-110j described above in respect of FIGS. 1-4. The communications network may comprise any suitable communications system, such as the communications system 100 described above in respect of FIGS. 1-4.

The network device 506 is comprised in the communications network. In particular examples, the network device 506 may be comprised in a radio access network of the communications network, such as the either of the RANs 120a-120b described above in respect of FIGS. 1-4. The network device 506 may be operable to connect an apparatus (such as the first apparatus 502 and/or the second apparatus 504) to a core network in the communications network. The network device 506 may, for example, comprise an access node (e.g., a base station). The network device 506 may comprise a TRP (such as any of the TRPs 170a-170b and NT-TRP 172 described above in respect of FIGS. 1-4). The network device 506 may comprise an evolved Node B, a gNode B, a pico base station, a femto base station, a remote radio head (RRH) or any other access node, for example.

The second apparatus 504 may be any apparatus suitable to communicate with the first apparatus 502 and network device 506. The second apparatus 504 may be comprised in the communications network. The second apparatus 504 may, for example, comprise an electronic device (such as, for example, any of the electronic devices 110a-110j described above in respect of FIGS. 1-4) or a TRP (such as any of the TRPs 170a-170b and NT-TRP 172 described above in respect of FIGS. 1-4). In particular examples, the second apparatus 504 may comprise a non-terrestrial apparatus (e.g., a non-terrestrial node) such as, for example, an aerial apparatus (e.g., an unmanned aerial apparatus, such as an unmanned aerial vehicle or drone). It may be particular advantageous to use a non-terrestrial apparatus since non-terrestrial apparatus may be able to receive requests for access from apparatus in remote locations.

In some examples, the second apparatus 504 may comprise a sensing node. Sensing nodes are network entities that perform sensing by transmitting and receiving sensing signals. Examples of well-known sensing methods include RADAR (Radio Detection and Ranging) and LIDAR (Light Detection and Ranging). Some sensing nodes may be communication equipment that perform both communications and sensing. However, it is possible that some sensing nodes do not perform communications and are, instead, dedicated to sensing. In examples in which the second apparatus 502 comprises a sensing node, the sensing node may perform both communications and sensing. The sensing node may, for example, comprise a sensing system (e.g., for sensing the first apparatus 502) in addition to a communication system (e.g., for communicating with other apparatus, such as the first apparatus 502 and the network entity 506).

In some examples, the sensing node may be configured to use a passive sensing technique (e.g., may be a passive sensing node). In a passive sensing technique, the target may be oblivious to the sensing process.

For example, a sensing node may be an apparatus operable to perform radio frequency (RF) sensing. RF sensing may be performed by transmitting one or more sensing signals (e.g., radio signals) and receiving a reflected signal comprising at least one reflection of the one or more sensing signals. The reflected signal may be used to infer information about the surroundings of the sensing node (e.g., the presence and/or position of one or more apparatus). The sensing node may thus comprise one or more transmitters for transmitting the one or more sensing signals and one or more receivers for receiving the reflected signal. The one or more transmitters and one or more receivers may form part of a communications system in the sensing node, for example. Alternatively, the one or more transmitters and one or more receivers may be separate to a communications system (e.g., a baseband unit) in the sensing node. The sensing node may comprise, for example, an electronic device such as any of the electronic devices 110a-110j described above in respect of FIGS. 1-4, or a TRP (such as any of the TRPs 170a-170b and NT-TRP 172 described above in respect of FIGS. 1-4).

The first apparatus 502 sends a first request 508 to the second apparatus 504 to connect to the communications network. The first request 508 may be referred to as an access request or an initial access request, for example. The first request 508 may take any suitable form provided the first request 508 indicates that access to the communications network is sought. The first request 508 may indicate that the first apparatus 502 seeks to transition to a connected state, such as, for example, an RRC CONNECTED state.

The first request 508 may be sent specifically to the second apparatus 504. Thus, for example, the first request 508 may be sent as a one-to-one (e.g., a unicast transmission) from the first apparatus 502 to the second apparatus 504. In some examples, the first request 508 may be sent as a one-to-many (e.g., a broadcast transmission) from the first apparatus 502 to one or more second apparatus 504.

The first apparatus 502 may identify (e.g., select) the second apparatus 504 in any suitable way. In some examples, the first apparatus 502 may be configured with an identifier for the second apparatus 504. For example, the first apparatus 502 may have been previously connected to the communications network and, prior to disconnecting from the network, the first apparatus 502 may have received an identifier and/or a location of the second apparatus 504 from another node in the network.

In some examples, the first apparatus 502 may identify the second apparatus based on the location of the first apparatus 502 and map of the network.

The skilled person will appreciate that there are various ways in which the first apparatus 502 may determine its own location. In an example, the first apparatus 502 may comprise a global navigation satellite system (GNSS) sensor such as, for example, a global positioning system (GPS) sensor and the first apparatus 502 may determine its location based on information from the GNSS sensor.

In another example, the first apparatus 502 may determine its location by transmitting one or more sensing signals and using a reflection of at least one of the one or more sensing signals to determine its location. For example, the first apparatus 502 may generate a first radio frequency map of its surrounding environment based on the reflected signals and compare it to a second radio frequency map (e.g., stored at the first apparatus 502) and based on the comparison, determine its location. In another example, the reflected signal may comprise identity and/or location information embedded in the reflected signal by the reflector. For example, a signal may be reflected by a tagged medium (e.g., a reflector comprising a radio frequency identification, RFID, tag) which embeds an indication of its location in the reflected signal. The first apparatus 502 may use the embedded location information to determine its own location. For example, the first apparatus 502 may determine the location of the reflector based on an indicator embedded in the reflected signal and determine its own location based on the location of the reflector and the travel time (e.g., round trip travel time) and transmission direction of the sensing signal.

In particular examples, a sensing signal may comprise a signal that does not carry data or control signals. As such, the sensing signal may be transmitted by the first apparatus 502 without use of, for example, a baseband unit in the first apparatus 502. This may allow the first apparatus 502 to transmit the sensing signal even when in an idle or low-power state.

The first apparatus 502 may use one or more images and/or videos of its environment and one or more stored images and/or videos to determine its location. For example, the first apparatus 502 may obtain (e.g., capture) images of its environment (e.g., its surrounding environment) using a camera in the first apparatus 502. The first apparatus 502 may compare the images to a one or more stored images, in which each stored image is associated with a respective location (e.g., in a map). The first apparatus 502 may thus determine its location based on the comparison of the captured images to the stored images.

The first apparatus 502 may use any combination of the aforementioned approaches for determining its own location. By combining two or more of the aforementioned approaches, the first apparatus 502 may determine its location more accurately and reliably. The skilled person will appreciate that the aforementioned examples of determining the location of the first apparatus 502 are provided by way of example only. In general, the first apparatus 502 may use any suitable method for determining its own location.

The map of the network (e.g., the network map) indicates a position of one or more other apparatus in the network, in which the one or more other apparatus include the second apparatus. The one or more other apparatus may be in a particular region of the network. Thus, for example, the network map may indicate a position of one or more other apparatus in a particular tracking area. In another example, the network map may indicate a position of one or more other apparatus in a group of tracking areas (e.g., a registration area). The first apparatus 502 may have been configured with the network map. Alternatively, the first apparatus 502 may have received the network map when the first apparatus 502 was previously connected to the network (e.g., at an earlier time).

In particular examples, the network map may further comprise mobility information for the one or more other apparatus. Thus, for example, the network map may indicate an expected mobility for the second apparatus 504. This may be particularly appropriate for mobile (e.g., non-fixed) second apparatus 504.

There are various ways in which the first apparatus 502 may identify the second apparatus based on the network map and the location of the first apparatus 502. For example, the first apparatus 502 may select the second apparatus responsive to determining, from the network map, that the second apparatus is closer than any of the other apparatus indicated in the network map. In another example, the first apparatus 502 may select the second apparatus responsive to determining, from the network map, that the second apparatus is within a predetermined distance or signal travel time of the first apparatus. The network map may take any suitable form such as, for example, a look-up table (LUT) or any other suitable form.

Thus, the first apparatus 502 may identify the second apparatus 504 based on its own location and a network map.

In some examples, the first apparatus 502 may identify the second apparatus 504 by transmitting one or more sensing signals and using a reflection of the one or more sensing signals to identify the second apparatus 504. Thus, for example, the second apparatus 504 may reflect at least one of the one or more sensing signals and the reflected signal may be received at the first apparatus 502. The one or more sensing signals may be transmitted in one or more directions. For example, the first apparatus 502 may be configured to transmit the one or more sensing signals in a particular direction. In another example, the first apparatus 502 may determine one or more directions to transmit the sensing signals (e.g., based on the network map and its own location). In another example, the first apparatus 502 may transmit the one or more sensing signals in a plurality of directions (e.g., performing a sweep).

The first apparatus 502 may infer the existence of the second apparatus 504 based on the received reflected signal. In particular examples, the second apparatus 504 may embed an identifier (e.g., a tag) in the reflected signal, in which the identifier indicates an identity and/or location of the second apparatus 504. The identifier may be passively embedded by the second apparatus 504. The first apparatus 502 may thus determine the identity and/or location of the second apparatus 504 based on an identifier embedded ion the reflected signal.

The first apparatus 502 may further transmit the first request 508 with a timing based on the location of the second apparatus 504. For example, the first request 508 may be transmitted with a timing advance (TA) based on the location of the first apparatus 502 relative to the second apparatus 504. There are various ways in which the first apparatus 502 may determine the location of the second apparatus 504. The first apparatus 502 may use network map to determine the location of the second apparatus 504, for example. The first apparatus 502 may determine the location of the second apparatus 504 based on a travel time of the reflected signal (e.g., a round trip travel time of the respective sensing signal and reflected signal), for example.

Thus there are many ways in which the first apparatus 502 may identify the second apparatus 504 prior to sending the first request 508 to connect to the network to the second apparatus 504.

In other examples, the first request 508 may not be sent specifically to the second apparatus 504. For example, the first apparatus 502 may broadcast the first request 508 and the broadcasted first request 508 may be received by the second apparatus 504. In another example, the first apparatus 502 may perform beam sweeping to transmit the first request 508. Thus, the first apparatus 502 may transmit the first request 508 on each of a plurality of beams and the second apparatus 504 may receive the first request 508 on at least one of the plurality of beams. The first apparatus 502 may thus send the first request 508 without first identifying the second apparatus 504.

The first request 508 indicates that the first apparatus 502 intends to connect to the network. The first request may indicate an identifier of the first apparatus 502. Any suitable identifier (e.g., identity) may be used. In some examples, the identifier may comprise a Radio Network Temporary Identifier (RNTI) such as, for example, a Cell-RNTI (C-RNTI) or a Temporary C-RNTI. In some examples, the identifier may comprise a sensing RNTI (S-RNTI).

The first request may indicate the location of the first apparatus 502. Thus, for example, the first apparatus 502 may determine its location and include its location to the second apparatus 504 in the first request 508. The first apparatus 502 may determine its location using any of the approaches discussed above. The location of the first apparatus 502 may be specified in any suitable way. Thus, for example, the location of the first apparatus 502 may be defined by one or more coordinates, such as one or more coordinates specifying a location of the first apparatus 502 relative to the second apparatus 504.

The information indicated in the request 508 may be comprised in the request 508. Thus, for example, the request 508 may comprise one or more of: an identifier of the first apparatus 502 and a location of the first apparatus 502.

Alternatively, some or all of the information indicated in the request may be determinable from the first request 508 (e.g., without being explicitly included in the request). For example, the first request 508 may comprise a sequence determined according to one or more parameters which are mapped to the location and/or identifier of the first apparatus 502. The sequence may comprise a Zadoff-Chu sequence, for example. The location may comprise a location index. In an example, the request 508 may comprise a Zadoff-Chu sequence having a root mapped to the location of the first apparatus 502 (e.g., a location index) and a shift value mapped to an identifier of the first apparatus 502.

In some embodiments, the first apparatus 502 may transmit the first request 508 according to a transmission configuration. The transmission configuration may comprise one or more transmission parameters for transmission of the first request 508 by the first apparatus 502. The transmission configuration may, for example, indicate one or more of the following: a waveform, a bandwidth, a time duration, a timing pattern and/or a symbol sequence to be used for transmission of the first request 508.

The timing pattern may indicate that the first apparatus 502 is to transmit the first request a particular number of times and/or at a particular time. For example, the timing pattern may indicate that the first request 508 is to be transmitted N times, in which N is greater than or equal to one. The timing pattern may indicate that the first request 508 may be transmitted at particular time intervals (e.g., with a particular periodicity), for example.

The first apparatus 502 may be configured with the transmission configuration. The first apparatus 502 may have been previously connected to the communications network and, prior to disconnecting from the network, the first apparatus 502 may have received the transmission configuration from another node in the network (e.g., from a network device, which could be the network device 502 or another network device). The first apparatus 502 may receive the transmission configuration in higher layer signalling such as, for example, Radio Resource Control (RRC) signalling or Medium Access Control (MAC) signalling. For example, the transmission configuration may be received at the first apparatus 502 in a MAC control element (MAC-CE).

The second apparatus 502 may be provided with the transmission configuration. Thus, for example, the second apparatus 504 may expect to receive the first request 508 according to a timing pattern indicated in the transmission configuration.

The first request 508 may be transmitted using physical layer (Layer 1) signalling. For example, the first request 508 may be transmitted on a physical uplink control channel (PUCCH). The first request 508 may form part of uplink control information (UCI) transmitted by the first apparatus 502, for example.

The second apparatus 504 sends a second request 510 to the network device 506 to connect the first apparatus 502 to the communications network. The second request 510 may be sent responsive to receiving the first request at the second apparatus 504.

The second request 510 corresponds to the first request 508. In some examples, the second apparatus 504 may forward the first request 508 as the second request (e.g., the second request 510 may be identical to the first request 508). Alternatively, the second apparatus 504 may determine the second request 510 based on the first request 508. For example, the second apparatus 504 may generate a message comprising information from the first request 508 and send the generated message as the second request 510. In another example, the second request 510 may comprise the first request 508.

The second request 510 may comprise one or more of: an identifier of the first apparatus 502 and the location of the first apparatus 502. The identifier of the first apparatus and/or the location of the first apparatus 502 may be received in the first request 508 as described above. The second apparatus 504 may determine the location of the first apparatus 502 based on the contents of the first request 508 (e.g., based on a sequence included in the first request 508 as described above). The second apparatus 504 may determine the location of the first apparatus based on the angle and/or direction from which the first request 508 was received. The second apparatus 504 may determine the location of the first apparatus based on the received power level of the first request signal 508. The second apparatus 504 may determine the location of the first apparatus based on any combination of the above.

The second apparatus 504 may send the second request 510 using any suitable channel. In particular examples, the second apparatus 504 may send the second request 510 using one or more of a Physical Uplink Shared Channel (PUSCH) and a Physical Uplink Control Channel (PUCCH). In some other example, the second apparatus 504 may send the second request 510 using a backhaul channel. For example, the second apparatus 504 may send a binary indicator (e.g., a single bit indicator) to the network device 506 on a PUCCH to indicate that the first apparatus 502 is requesting to access the network. This binary indication may be accompanied by the information of the first apparatus 502 communicated through a different channel (e.g., in a different message). In this case, the second apparatus 504 may, additionally or alternatively, send the location of the first apparatus 502 and/or an identifier of the first apparatus 502 to the network device 506 on, for example PUSCH.

Since both the second apparatus 504 and the network device 506 are in (e.g., connected to) the network, the second apparatus 504 may send the second request 510 to the network device 506 using one or more links in the network. The second apparatus may send the second request 510 directly or indirectly to the network device 506. In an example, the second apparatus may be connected to a cell served by the network device 506 and thus the second apparatus 504 may send the second request 510 directly to the network device 506. In another example, the second request 510 may be sent to the network device 506 via one or more intermediate apparatus (e.g., another helper or relay apparatus).

The network device 506 receives the second request 510 from the second apparatus 504. The network device 512 sends an instruction 512 to the second apparatus 504 to transmit a synchronization message to the first apparatus 502. The network device 512 may thus initiate transmission of the synchronization message to the first apparatus 502.

The instruction 512 may comprise a synchronization message to be sent to the first apparatus 502. The synchronization message may comprise one or more synchronization signals such as, for example, one or more of a primary synchronization signal (PSS) and a secondary synchronization signal (SSS). In particular examples, the synchronization message 514 may comprise a synchronization signal block (SSB).

The instruction 512 may indicate that the synchronization message is to be transmitted more than once. For example, the instruction 512 may indicate that the synchronization message is to be transmitted periodically (e.g., according to an indicated periodicity).

In some examples, the instruction 512 may comprise network information (e.g., network configuration information). For example, the instruction may comprise a physical broadcast channel (PBCH) comprising a master information block (MIB) and a system information block (SIB). The network information may be comprised in the synchronization message. For example, the instruction may comprise an SSB including a PSS, an SSS and an MIB.

Responsive to the instruction 512 from the network device 506, the second apparatus 504 transmits the synchronization message 514 to the first apparatus 502.

The synchronization message 514 is transmitted based on the location of the first apparatus 502. As described above, the second apparatus 504 may determine the location of the first apparatus 502 based on the first request 508 received from the first apparatus 502. As such, the second apparatus 504 may transmit the synchronization message 514 based on the location of the first apparatus determined from (e.g., received in) the first request 508.

Using the location of the first apparatus 502, the second apparatus 504 may transmit the synchronization message 514 directly to the first apparatus 502. Thus, for example, the second apparatus 504 may transmit the synchronization message 514 using a beam determined based on the location of the first apparatus 502.

However, in some examples, the location determined from the first request 508 may not specify the location of the first apparatus 502 precisely enough for the synchronization message to be transmitted directly to the first apparatus 502. Moreover, even if the location is sufficiently precise, it is possible that the first apparatus 502 may have moved, and the location may no longer be up to date.

As such, in some embodiments, the second apparatus 504 transmits the synchronization message over a plurality of beams. The plurality of beams are determined based on the location of the first apparatus 502. Thus, for example, the plurality of beams may be a subset of beams selected according to the location of the first apparatus 502. The location of the first apparatus 502 may thus be used to reduce the number of beams transmitted by the second apparatus 504, reducing power consumption and saving network resources.

In particular embodiments, the plurality of beams may be further determined based on the environment of the first apparatus 502 and/or the second apparatus 504. For example, a radio frequency map of the surrounding environment of the apparatus 502 and apparatus 504 may be used to obtain one or more directions (e.g., comprising an angle of departure, AoD, and/or an angle of arrival, AoA) corresponding to one or more paths (e.g., one or more dominant paths) between the second apparatus 504 and first apparatus 502. The one or more directions may be which is used to determine plurality of beams (e.g., to determine the beam directions).

Transmitting the synchronisation message over the plurality of beams may be particularly advantageous when, for example, one or more other apparatus (e.g., in addition to the first apparatus 502) are present. The one or more other apparatus may be seeking to connect to the communications network, for example. Thus, for example, some or all of the operations described above may also be performed in respect of the one or more other apparatus. Sending the synchronisation message over the plurality of beams allows for efficiently communicating the synchronisation message to the one or more other apparatus in addition to the first apparatus. In particular examples, the plurality of beams may be selected based on the location of the first apparatus 502 and the one or more other apparatus.

The synchronization message 514 may correspond to a synchronization message received in the instruction 512. Alternatively, the second apparatus 514 may generate the synchronization message 514.

The synchronization message 514 comprises one or more synchronization signals such as, for example, one or more of a primary synchronization signal (PSS) and a secondary synchronization signal (SSS). In particular examples, the synchronization message 514 comprises a synchronization signal block (SSB).

The synchronization message may further comprise network information for accessing the communications network. The network information may correspond to the network information described above in respect of the instruction 512. For example, the synchronisation message may further comprise a PBCH.

The first apparatus 502 receives the synchronization message 514. The first apparatus 502 may, in response to the synchronization message, transmit a first random access message to the second apparatus 504. The first random access message may request an allocation of one or more network resources. The first random access message may comprise an identifier for the first apparatus 502 such as, for example, any of the identifiers discussed above. The first random access message may comprise a random access preamble, for example. The first random access message may be transmitted using a physical random access channel (PRACH), for example.

The second apparatus 504 may receive the first random access message and send a second random access message, corresponding to the first random access message, to the network device 506. The second apparatus 504 may forward the first random access message as the second random access message, for example (e.g., without any digital signal processing). This may be particularly appropriate in examples in which the second apparatus comprises an electronic device (e.g., any of the electronic devices 110a-j described above in respect of FIGS. 1-4). Alternatively, the second apparatus 504 may, responsive to receiving the first random access message, send a random access response to the first apparatus 502, in which the random access response comprises an allocation of one or more network resources to the first apparatus 502. This may be particularly appropriate in examples in which the second apparatus 504 comprises a T-TRP (e.g., the T-TRP 170 described above in respect of FIGS. 1-4) or NT-TRP (e.g., the NT-TRP 172 described above in respect of FIGS. 1-4).

In some examples, transmission of the first random access message and/or the second random access message may be omitted. For example, the second apparatus 504 may receive an identifier for the first apparatus 502 in the first request 508. Thus the first request 508 may effectively replace the first random access message. In some examples, a timing of the apparatus 502 may have already been obtained by the second apparatus 504 through receiving the first request 508. The timing (e.g., time adjustment) of the first apparatus 502 may be indicated to the network device 506 by the second apparatus 504, for example.

In the aforementioned signaling 500, the synchronization message 514 is transmitted from the second apparatus 504 to the first apparatus 502. This may be particularly appropriate when the first apparatus 502 is outside of the range of the network device 506. For example, the first apparatus 502 may be too far away from the network device 506 or there may be obstacles between the first apparatus 502 and the network device 506 making reliable communication difficult or impossible. As such, the second apparatus 504 may be used as a relay between the first apparatus 502 and the network device 506 when direct communication between the first apparatus 502 and network device 506 is not possible or is not reliable. The second apparatus 504 may thus, for example, be referred to as a relay node or relay apparatus.

In other embodiments, the synchronization message 514 may be transmitted from the network device 506 to the first apparatus 502 (e.g., directly from the network device 506 to the first apparatus 502). The transmission of the synchronization message 514 by the network device 506 may be in the same manner as described above in respect of the second apparatus 504. This may be particularly appropriate when the first apparatus 502 is within radio range of the network device 506, for example.

Additionally or alternatively, the first apparatus 502 may transmit the first random access message to the network device 506 (e.g., directly to the first network device 506). The first apparatus 502 may receive the second random access message from the network device 506. Thus, for example, the first apparatus 502 may receive the synchronisation message 514 from the network device 506 and respond, to the network device 506, with the first random access message. In another example, the first apparatus 502 may receive the synchronisation message 514 from the second apparatus 504 and the synchronisation message 514 may indicate a location of the network device 506 (e.g., a location of the network device 506 relative to the first apparatus 502 and/or a direction between the network device 506 and the first apparatus 502). The first apparatus 502 may transmit the first random access message to the network device 506 based on the indicated location.

In some examples, the network device 506 may transmit the synchronization message 514 to the first apparatus 502, responsive to receiving the second request 510 from the second apparatus 504. The second apparatus 504 may, for example, act as a relay for the request to connect to the network, and the first apparatus 502 and the network device 506 may communicate directly for subsequent communications

In other examples, the first request 508 transmitted by the first apparatus 502 may be received by the first network apparatus 506 (e.g., rather than the second apparatus 504). The first request 508 may be transmitted in the same manner described above in respect of transmission the second apparatus 504, except that it is received by (e.g., transmitted to) the network device 506. Responsive to receiving the first request 508, the network device 506 may transmit the synchronization message 514 to the first apparatus 502.

As such, in some examples the second apparatus 504 may not be needed to relay between the first apparatus 502 and the network device 506. In a particular example, the second apparatus 504 may be used to provide supplementary location information for the first apparatus 502. The second apparatus 504 may, for example, comprise a sensing node. The sensing node may be configured to monitor the location of the first apparatus 502 and indicate the location of the first apparatus 502 to the network device 506. Methods for monitoring the location of the first apparatus 502 are discussed in more detail below. The network device 506 may transmit the synchronization message 514 based on the location received from the second apparatus 504. For example, the network device 506 may use the location of the first apparatus 502 as indicated by the first request 508 in combination with the location of the first apparatus 502 as indicated by the second apparatus 504 to determine a more accurate location estimate. The location estimate may then be used to transmit the synchronization message 514 (e.g., to select one or more beams for transmission of the synchronization message 514).

Embodiments of the present disclosure thus provide methods in which the location of the first apparatus 502 can be used to inform transmission of the synchronization signal 514 to the first apparatus 502. This can save power at both the first apparatus 502 and the apparatus that transmits the synchronization signal (e.g., the second apparatus 504 or the network device 506) by reducing the number of beams over which the synchronization signal needs to be transmitted. In particular examples, network resources may be saved by removing the need to transmit a random access preamble.

In the aforementioned description, the signaling 500 is initiated by the first apparatus 502. That is, the apparatus seeking to connect to the network initiates the access procedure. As such, the transmission of the synchronization signal to the first apparatus 502 is effectively performed on request by the first apparatus 502. This minimises network resource usage and saves transmission power at the apparatus transmitting the synchronization signal (e.g., the second apparatus 504 or the network device 506) In other embodiments, the access procedure may be initiated by the network.

In some embodiments, instead of transmitting the first request 508 to request to connect to the network, the first apparatus 502 may embed a request to connect to the network in a sensing signal that is reflected by the first apparatus 502.

The second apparatus 504 may transmit a sensing signal towards (e.g., in the direction of) the first apparatus 502 and the first apparatus 502 may reflect the sensing signal to produce a reflected signal. The first apparatus 502 may embed, in the reflected signal, a request to access the communications network. The request may comprise the first request 508 discussed above. The first apparatus 502 may comprise one or more components which may be operational even when the first apparatus 502 is not connected to the network (e.g., when the first apparatus 502 is an idle or inactive state). Such components may be RF components, analog components, or a subset of baseband components. Such components may be known as “passive” components in the sense that the passive components are used when the first apparatus is not actively connected to the network. As such, the one or more passive components may be used to embed the request 508 in the reflected signal even when the first apparatus 502 is in an idle or inactive state or generally in the power saving mode. The one or more passive components may embed the request 508 without employing the use of the baseband unit, for example. Embedding the request 508 in the reflected signal thus provides a power and resource-efficient solution for the first apparatus 502 to request to join the network.

In some embodiments, one or more of operations of the signaling 500 may be performed even if the first apparatus 502 does not transmit the first request 508 or embed a request to connect to the network in a reflected signal.

In particular, the signaling 500 may begin with the network device 506 sending the instruction 512 to transmit the synchronization message to the second apparatus 504. By sending the instruction 512 to transmit the synchronization message to the second apparatus 504, the synchronization message may still reach the first apparatus 502 even if direct communication between the first apparatus 502 and the network device 506 is difficult or impossible. This allows for connecting apparatus (e.g., electronic devices) to a network even when they are remotely located from an access node.

The network device 506 may send the instruction 512 responsive to obtaining (e.g., receiving or generating) data for transmission to the first apparatus 502. The network device 506 may send the instruction 512 responsive to determining that the first apparatus 502 is to transmit data (e.g., the first apparatus 502 is due to wake up). For example, the network device 506 may receive an indication (e.g., from a node in a core network of the communications network) that the first apparatus 502 is, or is likely to, transmit data. This may be particularly appropriate when the first apparatus 502 is configured to transmit data at particular intervals (e.g., to perform periodic reporting).

The network device 506 may thus initiate the access procedure. The network device 506 may select the second apparatus 504 from a plurality of apparatus. For example, the network device 506 may select the second apparatus 504 based on its proximity to the expected position of the first apparatus 502. The expected position of the first apparatus 502 may be based on its last known position (e.g., from when it was last connected to the network) and/or based on its last known velocity and direction of movement (e.g., from when it was last connected to the network). In some embodiments, the expected position of the first apparatus 502 in three-dimensional space, x, can be obtained from x=x₀+v₀t, in which x₀ is position of the first apparatus 504 at a first time (e.g., a last known position), v₀ is a velocity of the first apparatus 504 at the first time (e.g., a last known velocity) and t is the time since the first time (e.g., the time elapsed since the first apparatus 502 was last connected to the communications network).

The skilled person will appreciate that the operations described above in respect of FIG. 5 need not be performed in the described order. For example, in some embodiments, the network device 506 may send the instruction 512 to transmit the synchronization message to the first apparatus 502 before the second apparatus 504 receives the first request 508. The second apparatus 504 may send the synchronization message 514, as instructed by the network device 506, responsive to receiving the first request 508.

The foregoing description refers to transmission of a synchronization message 514 from the second apparatus 504 to the first apparatus 502. The skilled person will appreciate that a synchronization message 514 may be sent to the first apparatus 502 as part of a procedure for connecting the first apparatus 502 to the communications network. In general, the signaling 500 described above may be applied to other messages received by the first apparatus 502 part of a procedure to connect to (e.g., access a network). Thus, in some embodiments, the synchronization message 514 may be replaced by an access message (e.g., initial access message) comprising information to assist the first apparatus 502 in accessing the network. The access message may comprise information about the communications network (e.g., network information). The access message may comprise one or more of: one or more waveform parameters (e.g., indicating a shape and/or form of a signal to be transmitted), a frame number (e.g., a system frame number), a sub-carrier spacing (e.g., a common sub-carrier spacing), a sub-carrier offset, configuration information about the first network device 506 and/or a cell served by the first network device 506). The access message may comprise a PBCH, for example (e.g., in addition to or instead of one or more synchronisation signals). The access message may be transmitted in the same manner as the synchronization message 514.

### Sensing

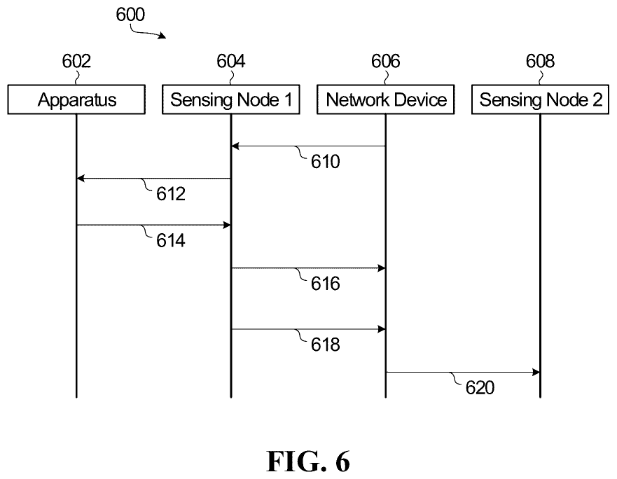

FIG. 6 shows signaling between an apparatus 602, a first sensing node 604, a network device 606 and a second sensing node 608 for a method for monitoring a location of the apparatus 602. The signaling may be performed whilst the apparatus 602 is in a low power state. The signaling may be performed whilst the apparatus 602 is in an inactive (e.g., RRC INACTIVE) or idle (e.g., RRC IDLE) state, for example.

The apparatus 602 may comprise the first apparatus 502 described above in respect of FIG. 5. In general, the apparatus 602 may comprise any apparatus in the network for which it is desirable to track its location. The apparatus 602 may thus comprise any mobile (e.g., moving or moveable) apparatus, for example. The apparatus 602 may comprise an electronic device, such as, for example, any of the electronic devices 110a-110j described above in respect of FIGS. 1-4.

The first sensing node 604 and the second sensing node 608 comprise any suitable sensing nodes (e.g., according to the description of sensing nodes above in respect of FIG. 5). For example, each of the first sensing node 604 and the second sensing node 608 may be operable to perform passive sensing, such as RF sensing. In particular examples, one of the first sensing node or the second sensing node may comprise the second apparatus 504 described above in respect of FIG. 5.

One or both of the first sensing node 604 and the second sensing node 608 may be a dedicated sensing node. In this context, a dedicated sensing node might not transmit or receive communication signals. However, the dedicated sensing node may communicate configuration information, sensing information, signaling information, or other information.

The network device 606 forms part of a communications network. The network device 606 is operable to connect other apparatus to the communications network. The network device 606 may comprise a transmit and receive point (TRP) such as, for example, any of the terrestrial TRPs 170a-170b or the non-terrestrial TRP 172 described above in respect of FIGS. 1-4. The network device 606 may comprise the network device 506 described above in respect of FIG. 5.

The network device 606 obtains a first location of the apparatus 602. The apparatus 602 may, for example, be connected to the communications network and its location may be known to the communications network. Alternatively, the apparatus 602 may have been previously connected to the communications network and the first location may comprise the last-known location of the apparatus 602. The network device 606 may obtain the last-known location of the apparatus 602 from a memory (e.g., a memory at the network device 606), for example. In a further example, the network device 606 may, for example, receive the first location of the apparatus 602 from a sensing node, such as the first sensing node 604 or the second sensing node 608.

Based on the first location of the apparatus 602, the network device 606 selects the first sensing node 604 from a first plurality of sensing nodes. Each of the plurality of sensing nodes may be operable to perform RF sensing. The network device 606 may select the first sensing node 604 based on the proximity of the first sensing node 604 to the first location of the first apparatus 502.

The network device 606 may additionally select the first sensing node 604 based on its capability. Different sensing nodes may be suited for sensing apparatus of different sizes, sensing apparatus of different mobilities, sensing in different environments and/or sensing over different timescales. As such, the first sensing node 604 may be further selected based on its capability and one or more of: a size of the apparatus 602, a mobility of the apparatus 602 (e.g., how quickly and/or in which direction it may move) the expected environment of the apparatus 602 and the timescale over which sensing is to be performed. The capability of the first sensing node 604 may comprise one or more of: a sensitivity of the sensing node 604 (e.g., the smallest apparatus it can detect), a mobility of the sensing node 604 and a power supply of the sensing node 604 (e.g., how much battery it has remaining).

In some embodiments, the sensing node 604 may be selected based on similarity between its mobility pattern (e.g., its most recent mobility pattern) and a mobility pattern of the apparatus 602 (e.g., the most recent mobility pattern of the apparatus 602). By selecting the sensing node 604 based on its mobility pattern, a sensing node that is likely to stay in the proximity of the apparatus 602 for a longer time may be selected.

In this embodiment, the network device 606 selects only one sensing node (the second sensing node 608). However, in general one or more sensing nodes may be selected. In particular examples, two or more sensing nodes may be selected from the plurality of sensing nodes and the two or more sensing nodes may be used to perform the operations of the first sensing node 604 described below. This may enable sensing to be performed collaboratively.

The network device 606 may preferably select a particular type of sensing node from the first plurality of sensing nodes. For example, the network device 606 may preferentially select a non-terrestrial sensing node (e.g., an aerial sensing node). Since non-terrestrial nodes are mobile and have a high capability for sensing, preferentially selecting non-terrestrial sensing nodes may enable monitoring the location of the first apparatus 60 more accurately and reliably. In some embodiments, the network device 606 may preferably select a large electronic device such as a vehicle (e.g., a car, a bus or a train) due to their high sensing and power capability. In some embodiments, the apparatus 602 may be physically located inside or in a close proximity of such an electronic device which makes selection of such electronic device as the sensing node 604 more preferable. Thus, for example, the network device 606 may select the sensing node 604 based on a determination that the apparatus is within or proximate to the sensing node 604.

The network device 606 sends a first instruction 610 to the first sensing node 604 to perform sensing on the apparatus 602. The network device 606 may thus request that the first sensing node 604 monitors (e.g., tracks) the location of the apparatus 602. The first instruction 610 may comprise the first location of the apparatus 602. In particular examples, the first instruction 610 may be sent to the first sensing node 604 using physical layer (Layer 1) signaling. For example, the first sensing node 604 may receive the first instruction 610 on a physical downlink control channel (PDCCH). The first instruction 610 may form part of downlink control information (DCI) transmitted from the network device 606 to the first sensing node 604, for example.

The first instruction 610 may comprise a sensing configuration. In other examples, the first sensing node 604 may be pre-configured with the sensing configuration. Alternatively, the first sensing node 604 may receive the sensing configuration separately to the instruction (e.g., from the network device 606 or from another apparatus in the network). The sensing configuration may be received using higher layer (e.g., RRC) signaling, for example.

The sensing configuration may indicate a sensing schedule. The sensing schedule may indicate one or more of: how often sensing is to be performed (e.g., at particular intervals), a start time indicating when sensing is to begin, a period of time over which sensing is to be performed and an end time indicating when sensing is to cease. The sensing schedule may, for example, indicate one or more time and/or frequency resources for transmitting a sensing signal (e.g., a particular frequency range). The sensing schedule may be determined to minimize interference with other signals.

The sensing configuration may indicate a signature and/or frequency shift associated with the apparatus 602. The apparatus 602 may be configured to apply (e.g., using one or more passive components at the apparatus 602) a signature and/or frequency shift to a sensing signal that reflects from (e.g., scatters from) the apparatus 602. The signature and/or frequency shift may be fixed or time varying, for example. The signature and/or frequency shift may be specific the apparatus 602, such that it can be used to identify the apparatus. The sensing configuration may thus indicate the signature and/or frequency shift associated with the apparatus 602 to enable the first sensing node 604 to identify a sensing signal that is reflected (e.g., scattered) by the apparatus 602. Applying the signature and/or frequency shift may also be known as modulation or modulating the sensing signal. A sensing signal reflection may also be known as scattering or backscattering, which may additionally include the aforementioned modulation.

The first sensing node 604 may send an acknowledgement to the network device 606 responsive to receiving the instruction (not illustrated). The acknowledgement may indicate to the network device 606 that the first sensing node 604 is to attempt to perform the instructed sensing.

The first sensing node 604 sends one or more sensing signals 612 to the apparatus 602. The one or more sensing signals may be sent according to the sensing configuration (e.g., according to the sensing schedule). The first sensing node 604 may send the one or more sensing signals 612 to one or more other apparatus in addition to the apparatus 602. The one or more sensing signals 612 may, for example, comprise common sensing signals used to sense a plurality of apparatus including the apparatus 602. This may be particularly appropriate in examples in which the sensing configuration indicates a frequency shift for the apparatus 602 as this may allow the first sensing node 604 to identify a common sensing signal that has reflected (e.g., backscattered) from the apparatus 602.

The first sensing node 604 receives a reflected signal comprising a reflection of at least one of the one or more sensing signals. Although the following description refers to a reflected signal for simplicity, the skilled person will appreciate that, in general, one or more reflected signals may be received at the first sensing node 604.

The apparatus 602 may embed the reflected signal 614 with a request to connect to the communications network. The reflected signal may thus, for example, comprise an indication of the request to connected to the communications network (e.g., as a tag embedded in the reflected signal). The request may comprise the first request 508 described above in respect of FIG. 5, for example. The request may be embedded as described above in respect of FIG. 5.

Based on the reflected signal, the sensing node 604 may determine a second location of the apparatus 602 and/or movement information for the apparatus 602. The movement information may comprise a velocity, a direction of movement and/or an acceleration of the apparatus 602. Thus, the reflected signal 614 may be used to estimate the position and/or movement of the apparatus 602. For example, the apparatus 602 may determine the second location of the apparatus 602 by determining an angle of arrival (AoA) of the reflected signal. As such, the sensing node 604 may monitor the position and/or movement of the apparatus 602 over time by sending sensing signals one or more times (e.g., in accordance with the sensing schedule). In some examples, the second position of the apparatus 602 may be determined based on an initial position of the apparatus 602 and the movement information. The initial position may comprise the first location or an earlier estimate of the location of the apparatus 602 determined by the sensing node 604, for example.

The first sensing node 604 sends sensing information 616 to the network device 606. The sensing information 616 may comprise the reflected signal 614. Thus, for example, the first sensing node 604 may relay the reflected signal without performing any processing. The network device 606 may determine, based on the reflected signal, the second location and/or the movement information for the apparatus 602.

The sensing information 616 may, additionally or alternatively, comprise the second location and/or movement information of the apparatus 602 determined by the first sensing node 604. The network device 606 may determine, based on the velocity determined from the sensing information, a direction of movement and the first location of the apparatus 602, an estimate of the second location. The estimate of the second location may be compared to the second location provided by the first sensing node 604 to monitor the accuracy of sensing, for example.

The first sensing node 604 may send the sensing information 616 as it is obtained. Alternatively, the first sensing node 604 may send the sensing information 616 at particular intervals (e.g., periodically). For example, the sensing schedule may indicate one or more times at which the first sensing node 604 is to send sensing information 616 to the network device 606. In another example, the first sensing node 604 may send the sensing information on request from the network device 606. Thus, the network device 606 may send a request for sensing information (e.g., separate to the first instruction 610) and in response, the first sensing node 604 may send the sensing information 616.

The first sensing node 604 may be mobile such that it can attempt to follow (e.g., track) the apparatus 602 if the apparatus 602 moves. This may be particularly advantageous for highly mobile apparatus 602 that may be otherwise difficult to track. However, as the apparatus 602 moves, the first sensing node 604 may no longer be able to sense the apparatus 602 due to, for example, increasing distance or presence of a blockage between the first sensing node 604 and the apparatus 602.

The present disclosure further provides a method for performing handover from a sensing node. Handover may be initiated by the first sensing node 604 or by the network device 606.

In the illustrated example, the first sensing node 604 initiates handover by sending a handover request 618 to the network device 606. The handover request 618 may indicate that the first sensing node 604 is ceasing performing sensing on the apparatus 602. The handover request 618 may be sent using physical layer (Layer 1) signaling. For example, the first sensing node 604 may send the handover request 618 on a physical uplink control channel (PUCCH).

The first sensing node 604 may send the handover request 618 responsive to failing to detect the apparatus 602. The first sensing node 604 may determine that the apparatus 602 is not detected in response to sending one or more sensing signals and not receiving any reflected signals (e.g., within a pre-determined period of time). In another example, the first sensing node 604 may determine that the apparatus 602 is not detected in response to receiving reflected signals with a power less than a threshold value. This may indicate that, for example, the first sensing node 604 is unable to track the apparatus 602 with a desired accuracy or sensitivity.

The first sensing node 604 may send the handover request 618 based on a power constraint and/or a processing constraint at the first sensing node 604. For example, the first sensing node 604 may have reached a minimum battery level and may thus cease to perform sensing. In another example, the first sensing node 604 may have received too many sensing instructions (e.g., to monitor too many apparatus) and may have insufficient power and/or processing capability to perform the instructed sensing. In another example, the first sensing node 604 may receive a higher priority tasks and thus determine to stop sensing the apparatus 602 (e.g., so that it can fulfil the higher priority sensing instruction).

In the illustrated embodiment, the first sensing node 604 successfully received the reflected signal 614 prior to sending the handover request 618. However, it will be appreciated that, in some examples, the first sensing node 604 may not be able to detect the apparatus 602 from the outset. For example, the first sensing node 604 may not receive any reflected signal.

The network device 606 receives the handover request 618. The network device 606 may determine to stop monitoring the location of the apparatus 602. The network device 606 may thus, for example, determine to cease sensing the apparatus 602. The signaling may thus end there.

Alternatively, the network device 606 may select the second sensing node 608 from a second plurality of sensing nodes. The second plurality of sensing nodes may be the same as the first plurality of sensing nodes from which the first sensing node 604 was selected. However, since the apparatus 602 may have moved since the first sensing node 604 was selected, the first plurality of sensing nodes may no longer be suitable. As such, in some embodiments, the first plurality of sensing nodes may differ from the second plurality of sensing nodes.

The second sensing node 608 may be selected from the second plurality of sensing nodes according to any of the approaches described above in respect of selecting the first sensing node 602 from the first plurality of sensing nodes.

The network device 606 sends a second instruction 620 to the second sensing node 608 to perform sensing on the apparatus 602. The second instruction 620 may comprise one or more of the features of the first instruction 610 described above. For example, the second instruction 620 may be transmitted over physical layer (Layer 1 signaling, such as on a PDCCH.

Embodiments of the present disclosure thus provide a method for monitoring the location of the apparatus 602 using sensing. Since the method does not require any explicit transmissions to be made by the apparatus 602, the location of the apparatus 602 may be monitored even if it is not connected to the communications network. As such, the method may be used to monitor the location of an apparatus in a low power state (e.g., an idle or inactive state). This means that the apparatus may be able to stay in the low power state for longer, saving power at the apparatus. It also means that the location of the apparatus may be readily available when the apparatus seeks to connect to a network, reducing latency and overhead in access procedures.

In particular examples, one or more of the operations described above in respect of FIG. 6 may be integrated into signaling as part of an access procedure for connecting an apparatus to a communications network. Thus, for example, one or more operations described above in respect of FIG. 6 may be implemented as part of the signaling 500 described above in respect of FIG. 5.

In an example, the sensing described in respect of FIG. 6 may be performed prior to the first apparatus 502 sending the first request 508 to access the network. The network device 506 may thus receive sensing information comprising a location of the first apparatus 502 (e.g., from the second apparatus 504). The synchronization message 514 may be transmitted based on the sensing information.

In another example, the first request 508 described in respect of FIG. 5 may be comprised in the reflected signal 614. The first request 508 may thus be passively embedded in the reflection of the one or more sensing signals 612.

By combining the sensing approach described in respect of FIG. 6 with the access approach described in respect of FIG. 5, the location of an apparatus seeking to connect to a network may be readily available even when the apparatus is in a low-power state. This can reduce latency and overhead when connecting the apparatus to the network.

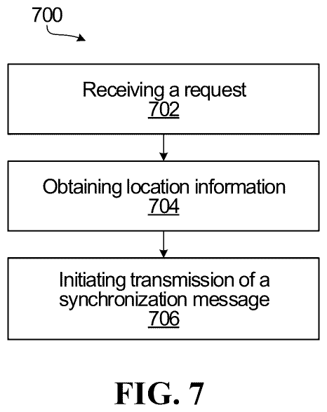

FIG. 7 shows a flowchart of a method 700 performed by a network device in a communications network. The network device may be in a radio access network of the communications network. The radio access network may comprise any of the radio access networks 120a-120b described above in respect of FIGS. 1-4, for example. The network device may comprise, for example, a TRP (e.g., any of the T-TRPs 170a-180b and the NT-TRP 172).

The network device may comprise the network device 506 described above in respect of FIG. 5, for example. The network device may comprise the network device 606 described above in respect of FIG. 6, for example.

In step 702, the network device receives a request to connect a first apparatus to the communications network. The request may correspond to the first request 508 described above in respect of FIG. 5. In an alternative example, the request may correspond to the second request 510 described above in respect of FIG. 5.

In step 704, the network device obtains location information indicating a location of the first apparatus. The location information may be received with the request. For example, the network device may receive the location information and the request from a second apparatus (e.g., in the second request 510 described above in respect of FIG. 5). In another example, the network device may receive the location information and the request from a first apparatus (e.g., in the first request 508 described above in respect of FIG. 5). In some examples, obtaining the location information may comprising receiving sensing information received from a sensing node. Thus, for example, step 704 may comprise receiving sensing information 618 as described above in respect of FIG. 6 and determining the location information using the sensing information.

In step 706, the network device initiates transmission of a synchronization message to the first apparatus based on the location information. Step 706 may comprise sending an instruction to a second apparatus to transmit the synchronization message. The instruction may comprise the instruction 512 described above in respect of FIG. 5, for example. Step 706 may comprise transmitting the synchronization message (e.g., as described in respect of the synchronization message 514 being transmitted from the network device 506 to the first apparatus 502 above).

In some embodiments, a network device is provided for performing the method 700. The network device may include a memory to store instructions (e.g., processor-executable instructions). The network device may further include a processor to perform operations such as steps of the method 700 described above. For example, the memory may store instructions which, when executed by the processor, cause the network device to perform the method 700 described above in respect of FIG. 7.

In some embodiments, a memory (e.g., a processor-readable memory or a processor-readable medium) is provided having stored thereon instructions (e.g., processor-executable) that, when executed by a processor, cause the processor to perform the steps of the method 700 described above in respect of FIG. 7. The processor may be associated with a network device, such as the network device 506 or the network device 606. For example, the processor may be or be a part of the network device.

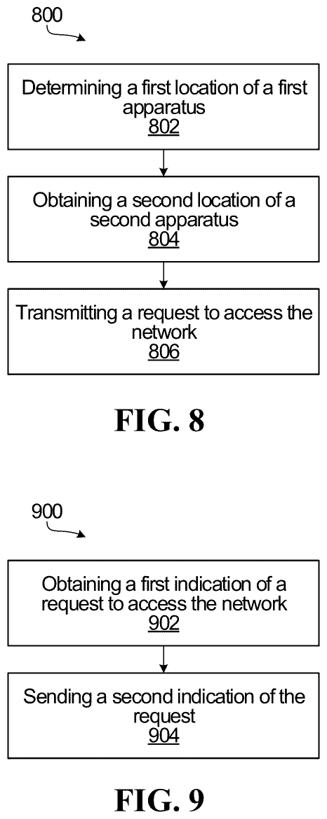

FIG. 8 shows a flowchart of a method 800 performed by a first apparatus. The first apparatus may comprise an electronic device, such as, for example, any of the electronic devices 110a-110j described above in respect of FIGS. 1-4. The first apparatus may comprise the first apparatus 502 described above in respect of FIG. 5. The first apparatus may comprise the apparatus 602 described above in respect of FIG. 6.

In step 802, the first apparatus determines a first location of the first apparatus. The first apparatus 802 may determine the first location using any of the approaches described in respect of FIG. 5 for the first apparatus 502 determining its own location.

In step 804, the first apparatus obtains a second location of a second apparatus in a communications network. The first apparatus may use any of the approaches described in respect of FIG. 5 for identifying the second apparatus 504.

In step 806, the first apparatus transmits a request, to the second apparatus, to access the communications network based on the first location and the second location. The request may be transmitted in accordance with the transmission of the first request 508 described above in respect of FIG. 5, for example.

In some embodiments, a first apparatus is provided for performing the method 800. The first apparatus may include a memory (e.g., a processor-readable memory or a processor-readable medium) to store instructions (e.g., processor-executable instructions). The first apparatus may further include a processor to perform operations such as steps of the method 800 described above. For example, the memory may store instructions which, when executed by the processor, cause the first apparatus to perform the method 800 described in respect of FIG. 8.

In some embodiments, a memory (e.g., a processor-readable memory or a processor-readable medium) is provided having stored thereon instructions (e.g., processor-executable) that, when executed by a processor, cause the processor to perform the steps of the method 700 described above in respect of FIG. 7. The processor may be associated with a first apparatus, such as the first apparatus 502 or the apparatus 602. For example, the processor may be or be a part of the first apparatus.

FIG. 9 shows a flowchart of a method 900 performed by a first apparatus in a communications network. The first apparatus may be comprised in the communications network. The first apparatus may comprise the second apparatus 504 described above in respect of FIG. 5. The first apparatus may comprise the first sensing node 604 described above in respect of FIG. 6.

In step 902, the first apparatus obtains a first indication of a request, by a second apparatus, to access the communications network. The request may correspond to the first request 508 described above in reference to FIG. 5. The first apparatus may, for example, receive a message comprising the request. The first apparatus may receive a reflected signal in which the request is embedded (e.g., as described above in respect of the reflected signal 614).

In step 904, the first apparatus sends, to a network device in the communications network, a second indication of the request, by the second apparatus, to access the communications network. The second indication of the request may comprise the second request 510 described above in respect of FIG. 5.

In some embodiments, a first apparatus is provided for performing the method 900. The first apparatus may include a memory (e.g., a processor-readable memory or a processor-readable medium) to store instructions (e.g., processor-executable instructions). The first apparatus may further include a processor to perform operations such as steps of the method 900 described above. For example, the memory may store instructions which, when executed by the processor, cause the first apparatus to perform the method 900 described in respect of FIG. 9.

In some embodiments, a memory (e.g., a processor-readable memory or a processor-readable medium) is provided having stored thereon instructions (e.g., processor-executable) that, when executed by a processor, cause the processor to perform the steps of the method 900 described above in respect of FIG. 9. The processor may be associated with a first apparatus, such as the second apparatus 504 or the first sensing node 604. For example, the processor may be or be a part of the first apparatus.

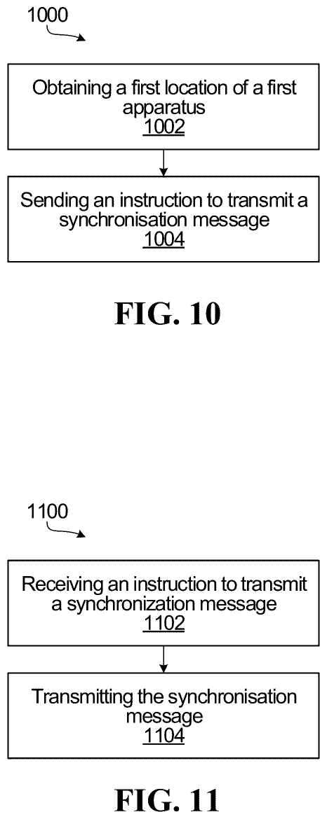

FIG. 10 shows a flowchart of a method 1000 performed by a network device in a communications network. The network device may be in a radio access network of the communications network. The radio access network may comprise any of the radio access networks 120a-120b described above in respect of FIGS. 1-4, for example. The network device may comprise, for example, a TRP (e.g., any of the T-TRPs 170a-180b and the NT-TRP 172).

The network device may comprise the network device 506 described above in respect of FIG. 5, for example. The network device may comprise the network device 606 described above in respect of FIG. 6, for example.

In step 1002, the network device obtains a location of a first apparatus. The network device may obtain the location of the first apparatus by obtaining sensing information from a sensing node (e.g., as described above in respect of FIG. 6). The network device may receive the location from the first apparatus or from a second apparatus (e.g., as described above in respect of FIG. 5).

In step 1004, the network device sends an instruction, to a second apparatus in the communications network, to transmit a synchronization message to the first apparatus based on the location of the first apparatus. The instruction may comprise the instruction 512 described above in respect of FIG. 5, for example.

In some embodiments, a network device is provided for performing the method 1000. The network device may include a memory (e.g., a processor-readable memory or a processor-readable medium) to store instructions (e.g., processor-executable instructions). The network device may further include a processor to perform operations such as steps of the method 1000 described above. For example, the memory may store instructions which, when executed by the processor, cause the network device to perform the method 1000 described in respect of FIG. 10.

In some embodiments, a memory (e.g., a processor-readable memory or a processor-readable medium) is provided having stored thereon instructions (e.g., processor-executable) that, when executed by a processor, cause the processor to perform the steps of the method 1000 described above in respect of FIG. 10. The processor may be associated with a network device, such as the network device 506 or the network device 606. For example, the processor may be or be a part of the network device.

FIG. 11 shows a flowchart of a method 1100 performed by a first apparatus in a communications network. The first apparatus may be comprised in the communications network. The first apparatus may comprise the second apparatus 504 described above in respect of FIG. 5. The first apparatus may comprise the first sensing node 604 described above in respect of FIG. 6.

In step 1102, the first apparatus receives an instruction to transmit a synchronization message to a second apparatus. The instruction is received from a network device in the communications network. The instruction may comprise the instruction 512 described above in respect of FIG. 5.

In step 1104, the first apparatus transmits the synchronization message based on the location of the first apparatus. The synchronization message may comprise the synchronization message 514 described above in respect of FIG. 5.

In some embodiments, a first apparatus is provided for performing the method 1100. The first apparatus may include a memory (e.g., a processor-readable memory or a processor-readable medium) to store instructions (e.g., processor-executable instructions). The first apparatus may further include a processor to perform operations such as steps of the method 1100 described above. For example, the memory may store instructions which, when executed by the processor, cause the first apparatus to perform the method 1100 described in respect of FIG. 11.

In some embodiments, a memory (e.g., a processor-readable memory or a processor-readable medium) is provided having stored thereon instructions (e.g., processor-executable) that, when executed by a processor, cause the processor to perform the steps of the method 1100 described above in respect of FIG. 11. The processor may be associated with a first apparatus, such as the second apparatus 504 or the first sensing node 604. For example, the processor may be or be a part of the first apparatus.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Numerous modifications and variations of the present disclosure are possible in light of the above teachings. It is therefore to be understood that within the scope of the appended claims, the disclosure may be practiced otherwise than as specifically described herein.

1. A method performed by a network device in a communications network, the method comprising:
receiving a request to connect a first apparatus to the communications network;
obtaining location information indicating a location of the first apparatus; and
initiating transmission of a synchronization message to the first apparatus based on the location information.

2. The method of claim 1, wherein obtaining the location information comprises receiving the location information from a second apparatus in the communications network.

3. The method of claim 2, wherein the method further comprises instructing the second apparatus to monitor the location of the apparatus responsive to determining that the first apparatus is in an idle state.

4. The method of claim 2, wherein the request to connect the first apparatus to the communications network is received from the second apparatus.

5. The method of claim 2, wherein initiating transmission of the synchronization message to the first apparatus comprises instructing the second apparatus to transmit the synchronization message to the first apparatus.

6. The method of claim 1, wherein obtaining the location information comprises receiving the location information from the first apparatus and wherein the request to connect the first apparatus to the communications network is received from the first apparatus.

7. The method of claim 1, wherein initiating transmission of a synchronization message to the first apparatus based on the location information comprises:
initiating transmission of the synchronization message to the first apparatus using one or more beams, wherein the one or more beams are determined based on the location information.

8. The method of claim 1, wherein the synchronization message comprises at least one of: a primary synchronization signal; a secondary synchronization signal; and a master information block.

9. A method performed by a first apparatus, the method comprising:
determining a first location of the first apparatus;
obtaining a second location of a second apparatus in a communications network; and
based on the first location and the second location, transmitting a request, to the second apparatus, to access the communications network.

10. The method of claim 9, wherein the request is transmitted with a timing advance determined based on the first location and the second location.

11. The method of claim 9, wherein obtaining the second location of the second apparatus comprises determining the second location of the second apparatus based on the first location and a map of the communications network.

12. The method of claim 9, wherein determining the first location of the first apparatus comprises:
storing an initial location of the first apparatus in response to transitioning to an idle state;
obtaining movement information using one or more sensors in the first apparatus; and
determining the first location of the first apparatus based on the initial location and the movement information.

13. The method of claim 9, wherein determining the first location of the first apparatus comprises:
transmitting a sensing signal;
receiving a reflection of the sensing signal, wherein the reflection comprises an indicator of a tag; and
determining the first location of the first apparatus based on the indicator of the tag.

14. An apparatus comprising:
a memory storing instructions; and
at least one processor caused, by executing the instructions, to cause the apparatus to:
determine a first location of the first apparatus;
obtain a second location of a second apparatus in a communications network; and
based on the first location and the second location, transmit a request, to the second apparatus, to access the communications network.

15. The apparatus of claim 14, wherein the request is transmitted with a timing advance determined based on the first location and the second location.

16. The apparatus of claim 14, wherein the instructions to cause the apparatus to obtain the second location of the second apparatus include instructions to cause the apparatus to determine the second location of the second apparatus based on the first location and a map of the communications network.

17. The apparatus of claim 14, wherein the instructions to cause the apparatus to determine the first location of the first apparatus include instructions to cause the apparatus to:
store an initial location of the first apparatus in response to transitioning to an idle state;
obtain movement information using one or more sensors in the first apparatus; and
determine the first location of the first apparatus based on the initial location and the movement information.

18. The apparatus of claim 14, wherein the instructions to cause the apparatus to determine the first location of the first apparatus include instructions to cause the apparatus to:
transmit a sensing signal;
receive a reflection of the sensing signal, wherein the reflection comprises an indicator of a tag; and
determine the first location of the first apparatus based on the indicator of the tag.
